(19) United States
(12) Patent Application Publication
(10) Pub. No.: US 2026/0313770 A1
(43) Pub. Date: Oct. 8, 2026

(54) MOTION-ACTIVATED ILLUMINATION SYSTEM FOR APPAREL AND OBJECTS

(71) Applicant: Graham Facer, St. George, UT (US)

(72) Inventor: Graham Facer, St. George, UT (US)

(21) Appl. No.: 19/638,332

(22) Filed: Apr. 3, 2026

Related U.S. Application Data
(60) Provisional application No. 63/783,594, filed on Apr. 4, 2025.
(60) Provisional application No. 63/794,059, filed on Apr. 24, 2025.
(60) Provisional application No. 63/842,712, filed on Jul. 11, 2025.
(60) Provisional application No. 63/912,734, filed on Nov. 6, 2025.

(51) Int. Cl. H05B 47/115; A41D 27/08; F21V 23/04; F21V 33/00; F21W 121/06; F21Y 103/10; F21Y 115/10; H05B 45/10; H05B 45/20; H05B 45/59; H05B 47/155; H05B 47/19

(52) U.S. Cl. CPC H05B 47/115; A41D 27/085; F21V 23/0471; F21V 23/0492; F21V 33/0008; H05B 45/10; H05B 45/20; H05B 45/59; H05B 47/155; H05B 47/19; F21W 2121/06; F21Y 2103/10; F21Y 2115/10

(57) ABSTRACT

A wearable garment with motion-activated illumination includes a garment body configured to be worn by a user, an inner layer removably attached to the garment body, and a motion-activated module coupled to the inner layer. The motion-activated module includes a processor, a motion sensor in communication with the processor, and a power source. The motion sensor includes an accelerometer configured to measure linear acceleration along three axes and a gyroscope configured to measure angular velocity along three axes. A plurality of lights are distributed across the inner layer and electrically connected to the motion-activated module. The processor is configured to determine a gravity vector based on accelerometer data, project the angular velocity onto the gravity vector to calculate a spin rate representing rotational velocity about a gravity-referenced axis, and control illumination of the lights based on the calculated spin rate.

### CROSS-REFERENCE TO RELATED APPLICATIONS

This application claims the benefit of U.S. Provisional Application Ser. No. 63/783,594 filed on Apr. 4, 2025, and further claims the benefit of U.S. Provisional Application Ser. No. 63/794,059, filed on Apr. 24, 2025, and further claims the benefit of U.S. Provisional Application Ser. No. 63/842,712, filed on Jul. 11, 2025, and further claims the benefit of U.S. Provisional Application Ser. No. 63/912,734, filed on Nov. 6, 2025, all of which are incorporated herein by reference.

### FIELD OF INVENTION

The present disclosure relates to motion-activated illumination systems for wearable items and objects. More particularly, the present disclosure relates to a wearable garment or other object incorporating a motion-activated module that detects rotational movement about a gravity-referenced axis and controls illumination of integrated lights in response to the detected movement.

### BACKGROUND

Garments and wearable items have long been used not only for their functional purposes of protection and coverage, but also as a means of personal expression and visual appeal. Entertainers, performers, and individuals seeking distinctive attire have explored various methods to enhance the visual impact of their clothing, including the use of bright colors, intricate designs, and decorative embellishments.

In recent years, the integration of lighting elements into garments has emerged as a technique for creating visually striking apparel. Illuminated clothing incorporating embedded light sources, such as light-emitting diodes (LEDs), has been developed for use in performances, costumes, and special event attire. These illuminated garments can provide visual effects that enhance the wearer's appearance and create memorable experiences for audiences.

Existing approaches to illuminated garments have included static lighting configurations where lights remain in a constant state, as well as pre-programmed lighting sequences that cycle through predetermined patterns. Some garments have incorporated motion-responsive switches that activate lights in response to general movement by the wearer. These motion-responsive switches typically function as binary triggers that connect a power source to light sources when movement is detected, causing the lights to flash or illuminate according to a pattern determined by a processor.

However, current illuminated garment technologies present certain limitations. Static lighting patterns and pre-programmed sequences do not adapt to the wearer's movements in real-time, resulting in a disconnect between the wearer's dynamic actions and the visual effects produced by the garment. Binary motion-responsive switches that simply trigger lights on or off in response to general movement do not provide graduated or proportional responses that correspond to the intensity or type of movement being performed.

Additionally, the integration of electronic components into garments presents practical challenges related to garment care and maintenance. Electronic modules that are permanently affixed to garments may be damaged during washing or may prevent the garment from being laundered using conventional methods. The routing of wiring and placement of light sources throughout a garment also presents design considerations for achieving desired visual effects while maintaining garment comfort and wearability.

Furthermore, distinguishing between different types of wearer movement presents technical challenges. A wearer may engage in various activities including walking, jumping, arm movements, and rotational spinning, each of which produces different motion characteristics. Detecting and responding appropriately to specific types of movement, such as rotational spinning about a vertical axis, while filtering out other types of motion or noise, involves considerations related to sensor selection, signal processing, and reference frame determination.

Accordingly, there exists an opportunity for advancements in motion-responsive illuminated garments, as well as other items or objects, that address these and other considerations in the field.

### SUMMARY

This summary is provided to introduce a selection of concepts in a simplified form that are further described below in the detailed description. This summary is not intended to identify key features or essential features of the claimed subject matter.

According to some aspects of the present disclosure, a wearable garment with motion-activated illumination is provided. The wearable garment includes a garment body configured to be worn by a user. The wearable garment includes an inner layer coupled to the garment body. The inner layer is configured to be removably attached to the garment body. The wearable garment includes a motion-activated module coupled to the inner layer. The motion-activated module includes a processor, a motion sensor in communication with the processor, and a power source. The motion sensor includes an accelerometer configured to measure linear acceleration along three axes and a gyroscope configured to measure angular velocity along three axes. The wearable garment includes a plurality of lights distributed across the inner layer and electrically connected to the motion-activated module. The processor is configured to determine a gravity vector based on accelerometer data from the accelerometer. The processor is configured to project the angular velocity measured by the gyroscope onto the gravity vector to calculate a spin rate representing rotational velocity about a gravity-referenced axis. The processor is configured to control illumination of the plurality of lights based on the calculated spin rate.

According to some aspects of the present disclosure, the wearable garment may include one or more of the following features. The processor may be configured to apply a low-pass filter to the accelerometer data to isolate the gravity vector. The processor may be configured to normalize the gravity vector to produce a unit vector. The processor may be configured to compute a dot product of an angular velocity vector from the gyroscope and the unit vector to calculate the spin rate. The processor may be configured to map a magnitude of the spin rate to a brightness level of the plurality of lights. The brightness level may increase proportionally with an increase in the magnitude of the spin rate.

The processor may be configured to apply filtering to the spin rate to reduce noise and prevent flicker of the plurality of lights. The filtering may include at least one of a low-pass filter, a deadband filter, or threshold detection. The plurality of lights may include light-emitting diodes. The plurality of lights may be arranged in a horizontal pattern extending around a circumference of the inner layer (e.g., spiral). The plurality of lights may be arranged in a vertical pattern (e.g., zig-zag) extending from a waistband region toward a hemline of the inner layer. The inner layer may be removably attached to the garment body, such as via a zipper. The garment body may include a dress having a bodice portion and a skirt portion. The inner layer may be positioned within the skirt portion. The motion sensor may include an inertial measurement unit comprising the accelerometer and the gyroscope integrated on a single device. The processor may include a microcontroller. The power source may include one or more batteries. The wearable garment may further include wiring routed through channels in the inner layer connecting the plurality of lights to the motion-activated module.

According to some aspects of the present disclosure, a method of providing motion-activated illumination in a wearable garment is provided. The method includes providing a wearable garment having a garment body, an inner layer removably coupled to the garment body, a motion-activated module coupled to the inner layer, and a plurality of lights distributed across the inner layer. The motion-activated module includes a processor, an accelerometer, a gyroscope, and a power source. The method includes measuring, by the accelerometer, linear acceleration data along three axes. The method includes measuring, by the gyroscope, angular velocity data along three axes. The method includes determining, by the processor, a gravity vector based on the linear acceleration data. The method includes projecting, by the processor, the angular velocity data onto the gravity vector to calculate a spin rate representing rotational velocity of the wearable garment about a gravity-referenced axis. The method includes controlling, by the processor, illumination of the plurality of lights based on the calculated spin rate.

According to some aspects of the present disclosure, the method may include one or more of the following features. Determining the gravity vector may include applying a low-pass filter to the linear acceleration data and normalizing the filtered data to produce a unit gravity vector. Projecting the angular velocity data onto the gravity vector may include computing a dot product of an angular velocity vector and the unit gravity vector. Controlling illumination of the plurality of lights may include mapping a magnitude of the spin rate to a brightness level of the plurality of lights. The brightness level may increase as the magnitude of the spin rate increases. The method may further include applying filtering to the spin rate to distinguish rotational spinning from other types of movement including walking, jumping, and arm movements. The method may further include removing the inner layer from the garment body via coupling mechanism (e.g., a zipper, snaps, Velcro®, etc.) for washing the garment body.

According to some aspects of the present disclosure, a motion-activated illumination system for a wearable item is provided. The motion-activated illumination system includes a motion-activated module. The motion-activated module includes a processor, an inertial measurement unit in communication with the processor, and a power source. The inertial measurement unit includes a three-axis accelerometer and a three-axis gyroscope. The motion-activated illumination system includes a plurality of lights electrically connected to the motion-activated module. The processor is configured to estimate a gravity vector from accelerometer data received from the three-axis accelerometer. The processor is configured to calculate a spin rate by projecting angular velocity data received from the three-axis gyroscope onto the estimated gravity vector. The processor is configured to modulate illumination of the plurality of lights proportionally to the calculated spin rate. The motion-activated module is configured to be coupled to a wearable item such that the spin rate corresponds to rotational velocity of the wearable item about a vertical axis defined by the estimated gravity vector, independent of an orientation of the inertial measurement unit within the wearable item.

According to some aspects of the present disclosure, the motion-activated illumination system may include one or more of the following features. The wearable item may include at least one of a dress, a skirt, a costume, a cape, an accessory, or a belt. The plurality of lights may include at least one of light-emitting diodes, fiber optics, or electroluminescent wire. The power source may include at least one of AAA batteries, a rechargeable battery, a lithium-ion battery, or a coin cell battery. The processor may be configured to apply signal conditioning to the spin rate including at least one of low-pass filtering, deadband filtering, or threshold detection. The processor may be configured to map the spin rate to a brightness level using at least one of a linear mapping function, a logarithmic mapping function, or an exponential mapping function. The motion-activated module may be configured to be removably coupled to the wearable item. The motion-activated module may be configured to be permanently coupled to the wearable item. The motion-activated illumination system may further include a speaker electrically connected to the motion-activated module. The processor may be configured to control sound output from the speaker based on the calculated spin rate.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a motion-activated module, according to aspects of the present disclosure.

FIG. 2 illustrates a front perspective view of a dress having a motion-activated module in a neutral state, according to aspects of the present disclosure.

FIG. 3 illustrates a front perspective view of a dress having a motion-activated module in an activated state, according to aspects of the present disclosure.

FIG. 4 illustrates a front perspective view of a dress comprising an inner layer having a motion-activated module and LEDs, according to aspects of the present disclosure.

FIG. 5 illustrates a front perspective view of an inner layer having a motion-activated module and spiral LEDs, decoupled from a dress, according to aspects of the present disclosure.

FIG. 6 illustrates a front perspective view of an inner layer having a motion-activated module and vertical zig-zag LEDs, decoupled from a dress, according to aspects of the present disclosure.

FIG. 7 illustrates a front perspective view of an inner layer of a dress with a motion-activated module being inserted therein, according to aspects of the present disclosure.

FIG. 8 illustrates a detailed view along the circle labeled FIG. 8 of FIG. 7, illustrating an LED of an inner layer.

### DETAILED DESCRIPTION

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

Motion-activated illumination systems for wearable garments provide dynamic visual feedback based on the physical movements of a wearer. Such systems may detect various types of motion, including rotational movement, and control illumination characteristics in response to the detected motion. The illumination may change in brightness, color, pattern, or other visual characteristics as a function of the motion detected.

In some cases, a motion-activated illumination system may be configured to detect rotational velocity of a garment about a vertical axis, such as when a wearer spins or twirls. The system may process motion data to determine the magnitude and direction of rotation, and may modulate illumination output accordingly. For example, the brightness of lights integrated into the garment may increase as rotational velocity increases, and may decrease as rotational velocity decreases.

Motion-activated illumination systems may employ various sensing technologies to detect movement. In some cases, inertial measurement units comprising accelerometers and gyroscopes may be used to measure angular velocity and linear acceleration. The system may process data from such sensors to distinguish between different types of motion, such as spinning, walking, jumping, or arm movements. By analyzing the sensor data, the system may isolate rotational motion about a particular axis and generate illumination responses corresponding to that motion.

In some cases, the motion-activated illumination system may determine a gravity vector using accelerometer data, and may project angular velocity measurements onto the gravity vector to calculate rotational velocity about the vertical axis. This approach may allow the system to detect rotation independent of the orientation of the sensor within the garment. The system may filter sensor data to reduce noise and prevent unintended illumination changes caused by minor movements or vibrations.

The illumination output of a motion-activated illumination system may be provided by various light sources, including light-emitting diodes, fiber optics, or electroluminescent materials. The light sources may be distributed throughout the garment in various configurations, such as horizontal bands, vertical strips, or other arrangements. The system may control the light sources using pulse-width modulation or other techniques to adjust brightness levels.

Motion-activated illumination systems may be powered by portable power sources, such as batteries, to allow for wearable operation. The electronic components of the system, including sensors, processors, and light sources, may be integrated into the garment structure or may be provided as removable modules. In some cases, the electronic components may be housed in a removable inner layer that can be separated from an outer garment layer for washing or maintenance purposes.

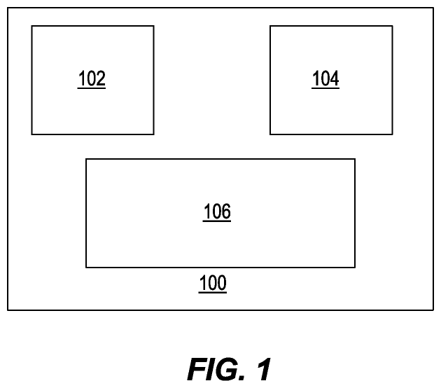

Referring to FIG. 1, a motion-activated module 100 may comprise a processor 102, a motion sensor 104, and a battery 106. The processor 102 may be configured to receive signals from the motion sensor 104 and to control illumination of lights coupled to a garment or other wearable item based on the received signals. The battery 106 may provide electrical power to the processor 102, the motion sensor 104, and associated light sources.

The motion sensor 104 may be configured to detect movement of the garment or wearable item. In some cases, the motion sensor 104 may be an accelerometer that measures linear acceleration along three axes. In some cases, the motion sensor 104 may be a gyroscope that measures angular velocity along three axes. In some cases, the motion sensor 104 may be a combination of an accelerometer and a gyroscope, such as a 6-axis inertial measurement unit (IMU). The motion sensor 104 may be an STMicroelectronics LSM6DS0 6-axis MEMS device providing 3-axis accelerometer and 3-axis gyroscope functionality. Other motion sensors capable of detecting rotational or linear movement may also be used.

With continued reference to FIG. 1, the processor 102 may be a microcontroller configured to process motion data received from the motion sensor 104. In some cases, the processor 102 may be a Microchip PIC16F152xx family 8-bit MCU. The processor 102 may communicate with the motion sensor 104 via an I2C bus interface. The I2C bus interface may allow the processor 102 to read motion data from the motion sensor 104 at a configurable data rate. The processor 102 may perform filtering, signal conditioning, and motion analysis operations on the received motion data to determine the type and magnitude of movement detected by the motion sensor 104.

The processor 102 may control LED brightness using pulse width modulation (PWM). By adjusting the duty cycle of the PWM signal, the processor 102 may modulate the brightness of LEDs or other light sources coupled to the motion-activated module 100. The processor 102 may map detected motion characteristics, such as rotational velocity, to corresponding brightness levels using linear, logarithmic, or other transfer functions.

As further shown in FIG. 1, the battery 106 may provide portable power for the motion-activated module 100. In some cases, the battery 106 may comprise three AAA batteries in series providing approximately 4.5V nominal voltage. In some cases, the power source may be a rechargeable battery, Li-ion battery, coin cell, external battery pack, or USB charging system. The selection of power source may depend on the size, weight, and power requirements of the motion-activated module 100 and associated light sources.

In some cases, the motion sensor 104 and the processor 102 may be combined onto a single printed circuit board (PCB). Combining the motion sensor 104 and the processor 102 onto a single PCB may reduce the size of the motion-activated module 100 and simplify integration into a garment or wearable item. A plurality of motion-activated modules 100, each comprising a combined processor 102 and motion sensor 104 on a single PCB, may be coupled to respective sets of lights to control different regions of a garment independently.

In some cases, a motion-activated module may comprise a housing containing a linear potentiometer, a spring positioned on a first side of the potentiometer, and a slidable weight positioned on a second side of the potentiometer. The spring may be configured to exert a force inward toward a resting state of the potentiometer. The slidable weight may be configured to exert a force against the potentiometer when actuated under centrifugal force, compressing the spring on the first side. When centrifugal force ends, the spring may extend, returning the potentiometer and the slidable weight to the resting state.

In operation, rotational movement of a garment or wearable item may generate outward centrifugal force. The centrifugal force may press the slidable weight against an actuator of the potentiometer, increasing resistance or voltage proportionally to spin intensity. When spinning slows or stops, the spring may reset the potentiometer to an original state. The potentiometer may thereby provide an analog signal corresponding to the magnitude of rotational motion without requiring complex digital processing.

In a relaxed state, the spring may be fully extended, forcing a potentiometer lever and the slidable weight to a first position. The first position may correspond to a low resistance or to an off position. As centrifugal force is applied to the motion-activated module, the force on the slidable weight may overcome the force of the spring, causing the spring to compress and moving the potentiometer lever toward a second end and a second position. The second position may correspond to increased resistance. The potentiometer resistance or voltage may increase as the potentiometer lever moves toward the second end, compressing the spring. When the centrifugal force lessens or ends, the spring may extend, returning the potentiometer lever and the slidable weight to the first position.

By utilizing a slidable weight and spring to move the potentiometer lever and control the potentiometer, complex processing may not be required. This approach may reduce or eliminate the need for microcontrollers or other processors, programming, and other steps that may increase cost and complexity. A user may elicit an action, such as illuminating lights or playing a sound, by exerting a force on the slidable weight sufficient to compress the spring.

In some cases, a motion-activated module may comprise an inertial trigger, weighted analog switch, or other mechanically actuated apparatus in place of a potentiometer for eliciting feedback under movement. An inertial trigger may be configured to close or open an electrical circuit in response to acceleration or deceleration forces. A weighted analog switch may be configured to provide a variable electrical output based on the position of a weighted element within a housing. Other mechanically actuated apparatuses may respond to movement by changing electrical characteristics such as resistance, capacitance, or inductance.

In some cases, a combination of motion detection methods may be used within a single garment or wearable item. For example, a potentiometer-based mechanism may be used to control illumination of lights in a skirt portion of a dress, where centrifugal force is most notable during spinning or twirling movements. The same garment may further comprise a processor and one or more sensors configured on other areas of the garment to control other effects, such as lighting at areas that may not experience centrifugal force. By incorporating more than one motion detection method and using a potentiometer for a portion of the garment, a user may achieve a variety of illumination effects while maintaining lower cost compared to using digital processing throughout the garment. However, it should also be noted that digital processing may be used for all illumination, rather than part analog and part digital processing.

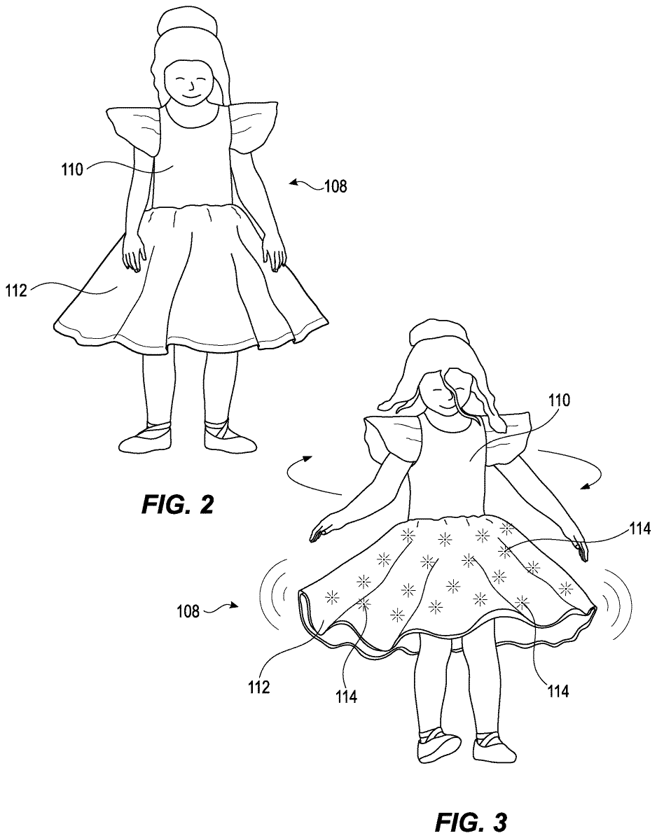

Referring to FIGS. 2-3, a dress 108 may comprise the motion-activated module 100 coupled thereto. FIG. 2 illustrates the dress 108 in a neutral, non-illuminated state, wherein the dress 108 is not in motion and lights associated with the motion-activated module 100 are not illuminated. The dress 108 may include a bodice portion 110 and a flared skirt portion 112 that extends outward from a waist of the dress 108 (individually or collectively a “garment body”). The motion-activated module 100 may be coupled to the dress 108 near an upper portion of the garment, such as at or near the bodice portion 110 or waistband region.

FIG. 3 illustrates the dress 108 in an activated state with lights 114 illuminated. When a wearer engages in movement, such as spinning or twirling, the motion-activated module 100 may detect the movement and cause lights 114 coupled to the dress 108 to illuminate. The transition from the neutral state shown in FIG. 2 to the activated state shown in FIG. 3 may occur in response to the motion-activated module 100 detecting rotational movement or other motion of the wearer.

The motion-activated module 100 may be permanently coupled to the dress 108. In some cases, the motion-activated module 100 may be sewn into the dress 108. Sewing the motion-activated module 100 into the dress may secure the motion-activated module 100 in a fixed position relative to the garment, allowing for consistent motion detection during wear.

In some cases, the motion-activated module 100 may be removably attached to the dress 108. The motion-activated module 100 may be removably attached using straps configured to secure the motion-activated module 100 to the dress 108. In some cases, the motion-activated module 100 may be removably attached using hooks and loops, such as Velcro® fasteners, that allow the motion-activated module 100 to be attached to and detached from the dress 108. In some cases, the motion-activated module 100 may be removably attached using elastics that stretch to accommodate attachment and removal of the motion-activated module 100. Other removable coupling mechanisms may also be used to removably attach the motion-activated module 100 to the dress 108.

Removable attachment of the motion-activated module 100 may allow the motion-activated module 100 to be removed from the dress 108 for purposes such as washing the dress 108, replacing the battery 106, or transferring the motion-activated module 100 to a different garment or wearable item. An illumination kit comprising the battery 106, lights 114, and the motion-activated module 100 may be configured with straps, hooks and loops, elastics, or other mechanisms for removably coupling the illumination kit to a user or garment. It will be appreciated that the motion-activated module 100 may be used not only with the dress 108, but with other wearable garment s(e.g., blouse, shirt, skirt, jacket, pants, etc.) or other wearable or non-wearable objects, such as a costume, a cape, a belt, a tiara, a wand, a stuffed animal, a ball, and a handheld toy, or other suitable objects or wearable garments.

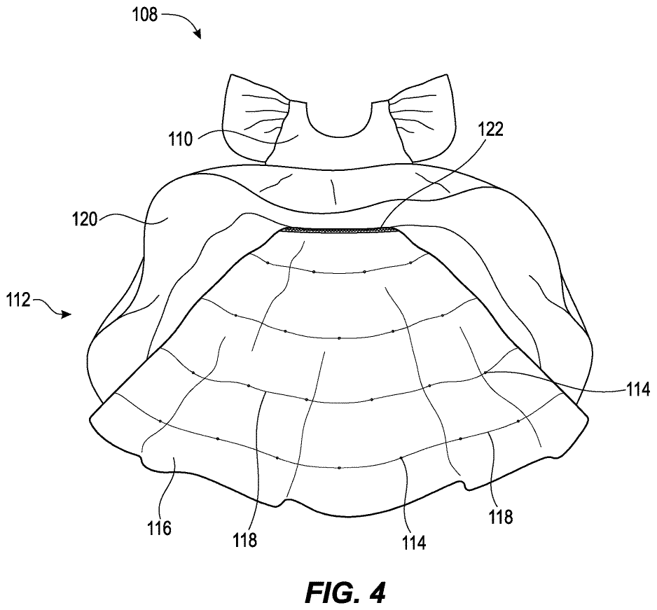

Referring to FIG. 4, a dress 108 may comprise an inner layer 116 having a motion-activated module 100 (not visible in this view) and lights 114 (e.g., LEDs) integrated therein. The dress 108 may include a bodice portion 110 at an upper section. The bodice 110 may connect to a skirt portion 112 that extends outward and downward from at the bottom portion of the bodice 110, which may be at or near the waist. The skirt portion 112 may be a single layer or may include multiple layered tiers that create a full, bell-shaped silhouette.

As further shown in FIG. 4, the inner layer 116 of the skirt portion 112 illustrates a series of horizontal lines running across the tiers, representing wires 118 featuring lights 114. Small dots positioned along the horizontal lines may indicate individual LED locations distributed throughout the inner layer 116. An outermost layer 120 of the skirt portion 112 may comprise a sheer or translucent overlay that drapes over the inner layer 116, allowing light from the lights 114 to be visible while concealing any associated wires 118.

The lights 114 integrated into the dress 108 may be light-emitting diodes (LEDs). LEDs may provide bright, energy-efficient illumination suitable for battery-powered wearable applications. In some cases, the lights 114 may be fiber optics. Fiber optics may transmit light from a central light source to various locations throughout the garment, creating distributed illumination effects. Fiber optic strands may be woven into or attached to fabric of the inner layer 116 to provide illumination along their length or at their termination points.

With continued reference to FIG. 4, the lights 114 may be addressable LEDs. Addressable LEDs may allow individual control of each LED in a string or array, enabling dynamic lighting effects such as color changes, animations, patterns, or sequencing effects that travel along the garment. In some cases, the lights 114 may be LED strips. LED strips may comprise a flexible substrate with multiple LEDs mounted thereon, allowing the LED strips to conform to curves and contours of the garment. In some cases, the lights 114 may be LED panels. LED panels may provide illumination over a defined area of the garment. In some cases, the lights 114 may be electroluminescent wire. Electroluminescent wire may emit light along its entire length when an electrical current is applied, providing a continuous line of illumination that may be shaped to follow seams, edges, or decorative patterns on the garment.

The lights may comprise approximately 50 to 100 individual LEDs distributed throughout the garment, although more or fewer may be used without departing herefrom. The LEDs may be positioned along horizontal bands within the skirt portion 112 to provide circumferential illumination when the motion-activated module 100 detects movement. The distribution of LEDs throughout the garment may provide even illumination coverage across the skirt portion 112. The number of LEDs may be selected based on factors such as desired brightness, power consumption, and visual effect. The construction of the dress 108 may allow the inner layer 116 containing the electronic components to be positioned beneath a decorative outer layer 120, enabling the motion-activated lighting system to illuminate the garment when a wearer engages in spinning or twirling movements.

With continued reference to FIG. 4, the inner layer 116 may be removably attachable to the dress 108. For example, a top of the inner layer 112 may couple to the bodice 110 via a coupling mechanism 122, such as a zipper as shown, or snaps, buckles, straps, hook and loop, or other mechanisms.

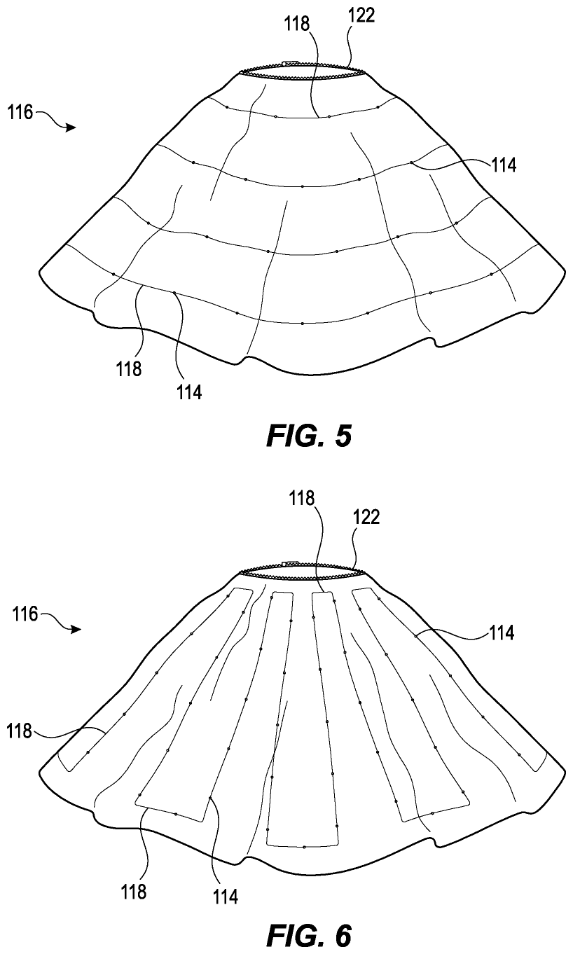

Referring to FIGS. 5-6, an article of clothing may comprise an inner layer 116 having a motion-activated module 100 and lights 114 therein, the inner layer 116 being removable from the clothing via a coupling mechanism 122 (e.g., zipper) for washability and/or to switch between articles of clothing. The inner layer 116 may have a conical or bell-shaped configuration representative of a skirt portion 112 of a dress 108. An upper edge of the inner layer 116 may include the coupling mechanism 122 for removably coupling the inner layer 116 to an outer dress layer 120 and/or bodice 110. The coupling mechanism 122 may allow a user to separate the inner layer 116 containing electronic components (e.g., motion-activated module 100, wiring 118, and lights 114) from the outer dress layer 120 and bodice 110, enabling the outer dress layer 120 and bodice 110 to be washed without exposing the electronic components to water or detergent.

As shown in FIG. 5, lights 114 may be integrated by horizontally winding the wiring 118 around the garment, such as beginning at the waist and spiraling to the bottom hemline. The wiring 118 may be housed within pathways or channels so as to avoid unwanted movement on the garment. The horizontal winding arrangement of the lights 114 may provide illumination that extends around the circumference of the skirt portion 112, creating a visual effect when the motion-activated module 100 detects movement and causes the lights 114 to illuminate.

FIG. 6 illustrates an alternative configuration wherein lights 114 may be integrated vertically within the garment. Wires 118 may extend from the waistband region downward toward the hemline, and may continue to a motion-activated module 100 which may be positioned near the waistband. The vertical integration of lights 114 may provide illumination effects that differ from the horizontal winding configuration, such as vertical streaks or columns of light that extend from the waist toward the hem of the skirt portion 112. The wiring patterns used may also simply be a function of the manufacturing process, with a manufacturer determining the arrangement of wires 118 and lights 114 thereon based upon manufacturing efficiencies.

The wires 118 for the lights 114 may be contained within a sleeve sewn onto the garment or in channels stitched into the garment. A sleeve may comprise a tubular fabric enclosure that is sewn onto a surface of the inner layer 116. The sleeve may receive wires 118 or LED strips, holding the wires or LED strips in position along the inner layer 116 while allowing the wires 118 and LED strips to be inserted into or removed from the sleeve. The sleeve configuration may provide an alternative to channels formed within the fabric of the inner layer 116. Sewing a sleeve onto the inner layer 116 may simplify manufacturing by allowing the sleeve to be attached after the inner layer 116 is constructed, rather than forming channels during construction of the inner layer 116.

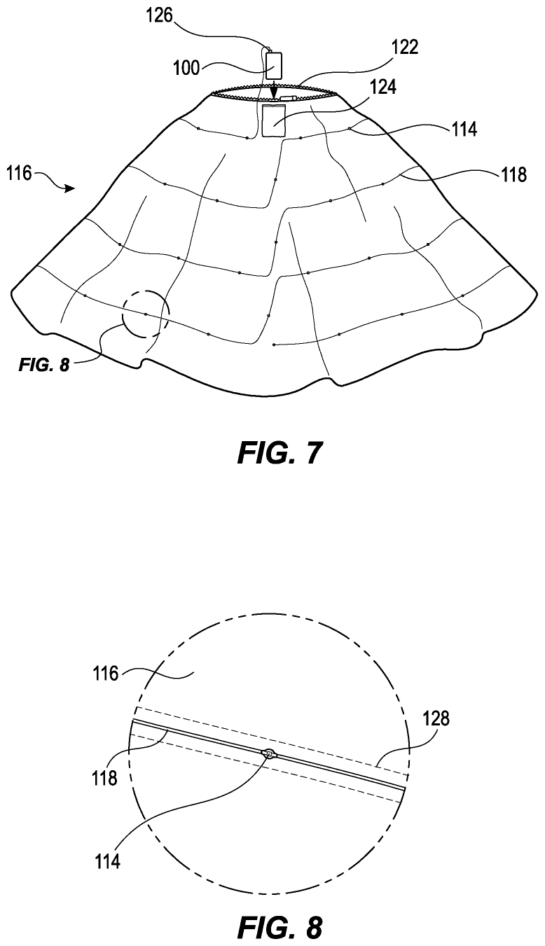

Referring to FIG. 7, an inner layer 116 of a dress 108 may be configured to receive a motion-activated module 100 therein. The motion-activated module 100 may be positioned at the waistband area, where the motion-activated module 100 may detect rotational movement of a wearer and control illumination of lights 114 distributed throughout the inner layer 116. The motion-activated module 100 may be inserted into a pocket 124, sleeve, or receptacle formed in the waistband region of the inner layer 116. The pocket 124, sleeve, or receptacle may be sized and shaped to receive the motion-activated module 100 and hold the motion-activated module 100 in a fixed, or generally fixed, position during wear. The motion-activated module 100 may be electrically connected to wiring 118 and lights 114 thereon within the inner layer 116 via a connector 126.

The ability to insert and remove the motion-activated module 100 from the inner layer 116 may facilitate maintenance of the garment. A user may remove the motion-activated module 100 from the pocket 124 from the inner layer 116 to replace a battery 106 or to service electronic components. The removable configuration may also allow a user to upgrade or replace the motion-activated module 100 with a different module having different functionality or capabilities, or to use the same motion-activated module 100 with a different article of clothing, reducing overall cost by utilizing one motion-activated module 100 across a plurality of garments.

The insertion and removal configuration may also facilitate washability of the garment. A user may remove the motion-activated module 100 from the inner layer 116 prior to washing the inner layer 116, protecting the electronic components of the motion-activated module 100 from exposure to water, detergent, or mechanical agitation during a washing process. The connector 126 may comprise a plug or other waterproof covering to prevent water and detergent from entering the connector 126 and associated wires 118. After washing and drying the inner layer 116, the user may reinsert the motion-activated module 100 into the inner layer 116 to restore motion-responsive lighting functionality to the garment. This configuration may extend the useful life of both the garment and the electronic components by allowing each to be maintained separately.

FIG. 8 illustrates an enhanced, detailed view along the circle labeled FIG. 8 in FIG. 7. As shown, the wire 118 passes through a channel 128 (or sleeve) to thereby secure its position relative to the inner layer 116. The wire 118 comprises lights 114 thereon, the lights 114 (e.g., LEDs, as shown) being controlled by the processor 102.

In some cases, a processor 102 may compute a gravity vector in real time using accelerometer data. The accelerometer may provide linear acceleration measurements along three axes, and the processor may apply a low-pass filter to the accelerometer data to isolate the gravity component from dynamic acceleration components caused by movement. The low-pass filter may attenuate high-frequency acceleration signals associated with rapid movements, vibrations, or impacts, while passing low-frequency signals that correspond to the static gravitational acceleration. The processor may compute the gravity vector as g_est=LPF(a), where “a” represents the raw accelerometer data vector and LPF represents the low-pass filtering operation.

The processor may normalize the gravity vector to produce a unit vector pointing toward Earth. Normalization may be performed by dividing the estimated gravity vector by its magnitude, such that g_hat=g_est/ |g_est|. The resulting unit vector g_hat may have a magnitude of one and may point in the direction of gravitational acceleration regardless of the orientation of the motion sensor within the garment. The unit gravity vector may serve as a reference axis for computing rotational velocity about the vertical axis.

The processor 102 may project an angular velocity vector onto the gravity axis to compute gravity-referenced rotational velocity. A gyroscope may provide angular velocity measurements along three axes, represented as ω=[ωx, ωy, ωz]. The processor may compute the projection of the angular velocity vector onto the unit gravity vector using a dot product operation, such that ω_spin=ω·g_hat. The resulting scalar value ω_spin may represent the rotational velocity about the gravity axis, corresponding to spinning or twirling motion about the vertical axis.

The projection of angular velocity onto the gravity axis may provide rotational velocity measurement independent of sensor 104 orientation within the garment. Because the processor 102 dynamically determines the gravity vector using accelerometer data and projects the angular velocity onto that dynamically determined axis, the processor 102 may detect rotation about the vertical axis regardless of how the motion sensor 104 is mounted or oriented within the garment. This approach may eliminate requirements for precise mechanical alignment of the motion sensor during garment construction.

An IMU may be configured for continuous accelerometer and gyroscope sampling at medium-to-high data rates. In some cases, the IMU may be configured with an output data rate of 104 Hz. In some cases, the IMU may be configured with an output data rate of 416 Hz. In some cases, the IMU may be configured with an output data rate between 104 Hz and 416 Hz. The selected data rate may provide sufficient temporal resolution to capture rotational motion during spinning or twirling movements while balancing power consumption and processing requirements.

The IMU may be configured with full-scale selection appropriate for child spin velocities. The gyroscope may be configurable with full-scale ranges such as ±125 degrees per second, ±250 degrees per second, ±500 degrees per second, ±1000 degrees per second, or ±2000 degrees per second. A full-scale range may be selected based on expected rotational velocities during typical use. For garments intended for children, the full-scale range may be selected to accommodate rotational velocities generated during spinning or twirling play activities while providing sufficient resolution to detect variations in spin speed. The accelerometer may be configurable with full-scale ranges such as ±2 g, ±4 g, ±8 g, or ±16 g, and a full-scale range may be selected to accommodate expected acceleration magnitudes during movement.

The processor 102 may apply multiple stages of digital filtering to motion data received from the motion sensor 104. Digital filtering may condition the motion data to reduce noise, eliminate spurious signals, and prevent unintended illumination changes that could result from movements other than spinning or twirling. The filtering stages may operate on the computed gravity-referenced rotational velocity to produce a filtered spin signal suitable for controlling LED brightness.

The processor 102 may apply low-pass filtering to the computed rotational velocity signal. Low-pass filtering may attenuate high-frequency components of the rotational velocity signal that correspond to rapid fluctuations, vibrations, or transient movements. By removing high-frequency noise from the rotational velocity signal, low-pass filtering may smooth the signal and reduce jitter in the resulting LED brightness output. The low-pass filter may have a cutoff frequency selected to pass rotational velocity changes associated with spinning or twirling movements while attenuating higher-frequency noise components. The cutoff frequency may be selected based on expected spin dynamics during typical use of the garment.

The processor 102 may apply deadband filtering to the rotational velocity signal. Deadband filtering may define a range of rotational velocity values near zero within which the processor 102 treats the rotational velocity as zero. When the rotational velocity falls within the deadband range, the processor 102 may output a zero value regardless of the actual measured rotational velocity. Deadband filtering may eliminate micro-movements and small oscillations in the rotational velocity signal that could otherwise cause LEDs to flicker or illuminate at low levels when a wearer is not actively spinning. The deadband range may be configured to encompass rotational velocity magnitudes that correspond to normal walking, standing, or minor body movements that are not intended to trigger illumination.

The processor 102 may apply thresholding to the rotational velocity signal. Thresholding may define a minimum rotational velocity magnitude below which the processor 102 does not activate LED illumination. When the rotational velocity magnitude is below the threshold, the processor 102 may maintain LEDs in an off state or at a minimum brightness level. When the rotational velocity magnitude exceeds the threshold, the processor 102 may begin modulating LED brightness based on the rotational velocity magnitude. Thresholding may prevent LED flicker at low spin velocities and may provide a defined transition point between non-illuminated and illuminated states of the garment.

The combination of low-pass filtering, deadband filtering, and thresholding may allow the processor 102 to distinguish between true body spin and other types of motion. Walking motion may produce rotational velocity signals that fall within the deadband range or below the threshold, preventing illumination during normal walking activities. Random arm motion may produce high-frequency rotational velocity components that are attenuated by low-pass filtering, preventing arm movements from triggering illumination. Fabric motion caused by wind or movement of the garment independent of body rotation may similarly be filtered or fall below threshold levels. The filtering stages may thereby isolate spinning or twirling motion as the trigger for LED illumination while rejecting other motion types. In some aspects, the filtered signals may also be used by the processor 102 to illuminate lights 114 (LEDs) when programmed accordingly, rather than remain in an off state.

The processor 102 may map the magnitude of the filtered rotational velocity signal to LED brightness using a transfer function. The transfer function may define a relationship between rotational velocity magnitude and LED brightness output. In some cases, the processor 102 may use a linear transfer function. A linear transfer function may produce LED brightness that increases proportionally with rotational velocity magnitude. For a linear transfer function, brightness may be computed as Brightness =|ω_spin|/ ω_max, where |ω_spin|represents the magnitude of the filtered rotational velocity and ω_max represents a maximum rotational velocity corresponding to maximum brightness. The linear transfer function may provide a direct correspondence between spin speed and brightness level.

In some cases, the processor 102 may use a logarithmic transfer function. A logarithmic transfer function may produce LED brightness that increases rapidly at low rotational velocities and more gradually at higher rotational velocities. The logarithmic transfer function may provide perceptual linearity, wherein perceived changes in brightness appear more uniform across the range of rotational velocities. Human perception of brightness may follow a logarithmic relationship, and a logarithmic transfer function may compensate for this perceptual characteristic.

In some cases, the processor 102 may use an exponential transfer function. An exponential transfer function may produce LED brightness that increases gradually at low rotational velocities and more rapidly at higher rotational velocities. The exponential transfer function may provide a more dramatic visual effect at higher spin speeds, with brightness increasing more noticeably as a wearer spins faster.

In some cases, the processor 102 may use a saturated transfer function. A saturated transfer function may produce LED brightness that increases with rotational velocity magnitude up to a saturation point, above which brightness remains at a maximum level regardless of further increases in rotational velocity. The saturation point may correspond to a rotational velocity magnitude at which LEDs reach maximum brightness. The saturated transfer function may prevent over-driving of LEDs at high rotational velocities and may provide consistent maximum brightness output once a wearer reaches a threshold spin speed.

The processor 102 may clamp the brightness output between minimum and maximum values. The minimum value may correspond to zero percent pulse-width modulation (PWM) duty cycle, representing LEDs in an off state. The maximum value may correspond to one hundred percent PWM duty cycle, representing LEDs at maximum brightness. Clamping may prevent the brightness output from exceeding the valid range of PWM duty cycle values regardless of the rotational velocity magnitude or transfer function used.

The processor 102 may control light brightness proportionally to spin velocity magnitude. As the magnitude of the filtered rotational velocity signal increases, the processor 102 may increase the PWM duty cycle applied to the LEDs, resulting in increased brightness. As the magnitude of the filtered rotational velocity signal decreases, the processor 102 may decrease the PWM duty cycle, resulting in decreased brightness. The proportional relationship between spin velocity magnitude and light brightness may provide visual feedback that corresponds to the intensity of spinning or twirling motion, with faster spinning producing brighter illumination and slower spinning producing dimmer illumination.

The processor 102 may be programmed to produce flickering or sparkling light effects. Flickering effects may comprise rapid variations in brightness that create a shimmering or twinkling appearance. The processor 102 may generate flickering effects by modulating the PWM duty cycle with a random or pseudo-random component superimposed on the base brightness level determined by spin velocity. Sparkling effects may comprise brief, localized increases in brightness at individual LEDs or groups of LEDs within the garment. The processor 102 may generate sparkling effects by momentarily increasing the brightness of selected LEDs while maintaining other LEDs at a base brightness level. The selection of LEDs for sparkling may be randomized or may follow a predetermined pattern. Flickering and sparkling effects may enhance the visual appeal of the illuminated garment by adding dynamic variation to the lighting output.

The processor 102 may be programmed to produce transitioning effects including fade-in and fade-out. Fade-in effects may comprise gradual increases in brightness from an off state or low brightness level to a higher brightness level. When the processor 102 detects the onset of spinning motion, the processor 102 may gradually increase LED brightness over a transition period rather than immediately setting the LEDs to the brightness level corresponding to the detected spin velocity. Fade-out effects may comprise gradual decreases in brightness from a higher brightness level to an off state or low brightness level. When the processor 102 detects cessation or reduction of spinning motion, the processor 102 may gradually decrease LED brightness over a transition period rather than immediately turning off the LEDs or reducing brightness to the level corresponding to the reduced spin velocity. The transition period for fade-in and fade-out effects may be configurable and may be selected to provide a smooth visual transition that enhances the aesthetic appearance of the illumination response. In some aspects, the lights 114 may be configured to maintain a baseline or minimum brightness level when the motion-activated module 100 is powered on, even in the absence of detected motion. When the processor 102 subsequently detects motion via the motion sensor 104, the processor 102 may increase the brightness of the lights 114 proportionally or according to predetermined illumination parameters.

The processor 102 may be programmed to produce different flashing or pulsing patterns. Flashing patterns may comprise periodic alternation between on and off states or between high and low brightness levels. The processor 102 may generate flashing patterns by periodically modulating the PWM duty cycle between maximum and minimum values or between two different brightness levels. Pulsing patterns may comprise periodic variation in brightness that follows a smooth waveform, such as a sinusoidal or triangular waveform. The processor 102 may generate pulsing patterns by modulating the PWM duty cycle according to a periodic function that produces gradual increases and decreases in brightness. The frequency of flashing or pulsing patterns may be fixed or may vary based on spin velocity magnitude. In some cases, faster spinning may produce faster flashing or pulsing rates, while slower spinning may produce slower flashing or pulsing rates.

The processor 102 may be programmed to change light color based on movement. In some cases, the lights 114 may start at a first color and transition to a second color in response to detected motion. For example, the lights 114 may start white and turn pink in response to spinning motion. In some cases, the lights 114 may start white and turn blue in response to spinning motion. The processor 102 may control color by adjusting the relative brightness of different color channels in multi-color LEDs, such as RGB LEDs that comprise red, green, and blue light-emitting elements. The processor 102 may transition between colors gradually over a transition period or may change colors abruptly when spin velocity exceeds a threshold. Color changes may provide additional visual feedback that distinguishes between different motion states or intensity levels.

The processor may 102 be programmed to produce animated patterns such as raindrops or bouncing effects. Raindrop patterns may comprise illumination effects that simulate drops of light falling or cascading across the garment. The processor 102 may generate raindrop patterns by sequentially illuminating LEDs along vertical paths from the waistband toward the hem, with each sequential illumination representing a raindrop traveling down the garment. Bouncing patterns may comprise illumination effects that simulate light bouncing or rebounding within the garment. The processor 102 may generate bouncing patterns by illuminating LEDs in sequences that travel in one direction, reverse direction upon reaching an endpoint, and travel back in the opposite direction. The speed of animated patterns may be fixed or may vary based on spin velocity magnitude. Animated patterns may provide dynamic visual effects that enhance the entertainment value of the illuminated garment.

The processor 102 may be programmed to produce different effects based on spin direction. The processor 102 may determine spin direction from the sign of the computed gravity-referenced rotational velocity. A positive rotational velocity may correspond to spinning in a first direction, such as clockwise when viewed from above, while a negative rotational velocity may correspond to spinning in a second direction, such as counterclockwise when viewed from above. The processor 102 may produce a first lighting effect when the wearer spins in the first direction and may produce a second lighting effect when the wearer spins in the second direction. In some cases, the processor 102 may illuminate the lights in a first color when the wearer spins in the first direction and may illuminate the lights in a second color when the wearer spins in the second direction. For example, spinning clockwise may produce pink illumination while spinning counterclockwise may produce blue illumination. Direction-based effects may provide visual feedback that distinguishes between different spin directions and may add an interactive element to the garment that encourages exploration of different movements.

In some cases, a motion-activated module 100 may produce sound via speakers in response to detected movement. The motion-activated module 100 may comprise one or more speakers coupled to a processor 102, wherein the processor 102 controls audio output based on motion data received from a motion sensor 104. The speakers may be integrated into a garment or wearable item, or may be housed within a sound module that is coupled to the garment. The speakers may provide auditory feedback in addition to visual illumination effects produced by lights 114 coupled to the motion-activated module 100.

The processor 102 may be programmed to generate audio signals that are output through the speakers when the motion sensor 104 detects movement. In some cases, the processor 102 may play pre-recorded sounds stored in memory when spinning or twirling motion is detected. The pre-recorded sounds may include musical tones, melodies, sound effects, or other audio content. In some cases, the processor 102 may synthesize sounds in real time based on characteristics of the detected motion, such as rotational velocity magnitude or direction.

The audio output may be modulated based on motion characteristics. In some cases, the volume of sound output may increase as rotational velocity increases and may decrease as rotational velocity decreases, providing auditory feedback that corresponds to the intensity of spinning motion. In some cases, the pitch or frequency of sound output may vary based on rotational velocity, with faster spinning producing higher-pitched sounds and slower spinning producing lower-pitched sounds. In some cases, the tempo or rhythm of sound output may vary based on rotational velocity, with faster spinning producing faster tempos and slower spinning producing slower tempos.

The processor 102 may be programmed to produce different sounds based on different types of detected movement. In some cases, the processor 102 may produce a first sound in response to spinning motion and may produce a second sound in response to jumping motion. In some cases, the processor 102 may produce different sounds based on spin direction, with spinning in a first direction producing a first sound and spinning in a second direction producing a second sound. The processor 102 may distinguish between different motion types using data from the motion sensor 104 and may select appropriate audio output based on the detected motion type.

In some cases, the motion-activated module 100 may produce sound output in coordination with illumination effects. The processor 100 may synchronize audio output with changes in light brightness, color, or pattern to provide a coordinated audiovisual experience. For example, the processor 102 may produce a sound effect when lights transition from an off state to an illuminated state, or may produce rhythmic sounds that correspond to flashing or pulsing light patterns. The coordination of sound and light output may enhance the immersive and interactive experience provided by the motion-activated module 100.

The speakers may be positioned within the garment to direct sound toward a wearer or toward an audience. In some cases, the speakers may be positioned near a waistband region of the garment. In some cases, the speakers may be distributed at multiple locations within the garment to provide spatial audio effects. The size and power of the speakers may be selected based on desired audio output levels and available power from a battery 106 or other power source coupled to the motion-activated module 100.

In some aspects, the motion-activated module 100 may further comprise an audio detection or input device, such as a microphone, configured to detect ambient sounds or music. The audio detection device may generate audio-based input signals that are processed by the processor 102. In response to the detected sounds or music, the processor 102 may be programmed to cause the lights 114 coupled to the motion-activated module 100 to illuminate according to predetermined audio-responsive parameters. This functionality may allow the lights 114 to synchronize with ambient audio rather than relying solely on motion-based triggers. In some aspects, the processor 102 may utilize a combination of motion data received from the motion sensor 104 and audio data received from the audio detection device to control illumination of the lights 114.

In some cases, a garment or wearable item may comprise a plurality of motion sensors 104, each motion sensor 104 configured to correspond with a respective plurality of lights 114. Each motion sensor 104 may be coupled to a respective set of lights, and each set of lights may perform different actions depending on which motion sensor 104 that particular set of lights is connected to. For example, a first motion sensor 104 may be positioned at a first region of the garment and may be coupled to a first set of lights positioned at or near the first region, while a second motion sensor 104 may be positioned at a second region of the garment and may be coupled to a second set of lights positioned at or near the second region. The first motion sensor 104 may detect movement at the first region and may cause the first set of lights to illuminate in response to the detected movement, while the second motion sensor 104 may independently detect movement at the second region and may cause the second set of lights to illuminate in response to movement detected at the second region.

The plurality of motion sensors 104 may allow different regions of the garment to respond independently to localized movements. Each motion sensor 104 may detect movement occurring at or near the region where that motion sensor 104 is positioned, and may control the corresponding set of lights based on the detected movement at that region. Movement at one region of the garment may cause illumination at that region without affecting illumination at other regions where movement has not been detected. This configuration may provide localized visual feedback that corresponds to specific body movements rather than overall body motion.

In some cases, each motion sensor 104 of the plurality of motion sensors may be combined with a respective processor 102 onto a single printed circuit board (PCB). Each PCB may be coupled to a respective set of lights to control that set of lights independently. The distributed arrangement of processors and motion sensors throughout the garment may allow each region to operate autonomously, with each processor processing motion data from its corresponding motion sensor and controlling its corresponding set of lights without requiring communication with other processors or a central controller.

A processor 102 may be configured to illuminate specific regions of a garment in response to detecting specific triggering movements. The processor 102 may analyze motion data from one or more motion sensors 104 to identify particular types of movements, and may activate illumination at regions of the garment that correspond to the detected movements. Region-specific triggering may provide visual feedback that highlights the body part or garment region involved in a particular movement.

In some cases, the processor 102 may be configured to illuminate a leg region of the garment in response to detecting a kick. A motion sensor 104 positioned at or near a leg portion of the garment may detect acceleration and angular velocity patterns characteristic of a kicking motion. The processor 102 may analyze the motion data to identify the kicking motion based on characteristics such as rapid forward acceleration of the leg, angular rotation about the hip or knee, or a combination of acceleration and rotation patterns. When the processor 102 identifies a kicking motion, the processor 102 may cause lights positioned at or near the leg region to illuminate, providing visual feedback that corresponds to the kick.

In some cases, the processor 102 may be configured to illuminate arm regions of the garment in response to detecting arms being raised above a threshold height. A motion sensor 104 positioned at or near an arm portion of the garment may detect orientation and movement of the arm. The processor 102 may determine the orientation of the arm relative to gravity using accelerometer data, and may compare the arm orientation to a threshold corresponding to a predetermined height such as shoulder height. When the processor 102 determines that the arm has been raised above the threshold height, the processor 102 may cause lights positioned at or near the arm region to illuminate. The threshold height may be configurable and may be set to correspond to shoulder height, head height, or another user-determined height.

The processor 102 may distinguish between different types of movements based on characteristics of the motion data. Kicking motions may produce motion data patterns that differ from arm-raising motions, spinning motions, or walking motions. The processor 102 may apply pattern recognition, threshold detection, or other analysis techniques to the motion data to classify the detected movement and determine which regions of the garment to illuminate. Different movement types may trigger illumination at different regions, providing visual feedback that corresponds to the specific movement performed by the wearer.

In some cases, a motion-activated module 100 may be configured to detect jump activation. The processor 102 may analyze accelerometer data to identify acceleration patterns characteristic of jumping. A jump may produce a characteristic acceleration pattern comprising an initial downward acceleration as the wearer crouches, followed by upward acceleration as the wearer pushes off the ground, followed by a period of reduced acceleration or freefall while the wearer is airborne, followed by a deceleration spike upon landing. The processor 102 may detect one or more of these acceleration phases to identify a jump.

When the processor 102 detects jump activation, the processor 102 may cause lights coupled to the garment to illuminate or may trigger a specific lighting effect associated with jumping. The lighting effect triggered by jump detection may differ from lighting effects triggered by spinning or other movements. In some cases, jump detection may trigger a flash of light coinciding with the moment of takeoff or landing. In some cases, jump detection may trigger a pulsing or rippling light effect that travels through the garment. The processor 102 may be programmed with different lighting responses for different detected movements, allowing the garment to provide varied visual feedback based on the type of movement performed by the wearer.

In some cases, a motion-activated module 100 may include wireless communication capabilities. The motion-activated module 100 may comprise a wireless transceiver configured to communicate with external devices. The wireless transceiver may be a Bluetooth® transceiver configured to establish wireless communication links with smartphones, tablets, computers, or other Bluetooth-enabled devices. The wireless transceiver may operate according to Bluetooth Low Energy (BLE) protocols to reduce power consumption while maintaining wireless connectivity.

The wireless communication capabilities may allow a user to control the motion-activated module 100 from an external device. A user may operate a smartphone application that communicates with the motion-activated module 100 via Bluetooth to adjust settings, select lighting modes, or configure motion response parameters. The smartphone application may provide a graphical user interface that displays available options and allows the user to modify settings by interacting with the interface. Changes made through the smartphone application may be transmitted wirelessly to the motion-activated module 100, which may update its operating parameters accordingly.

In some aspects, the motion-activated module 100 may comprise a wireless transceiver configured to pair with one or more additional motion-activated modules 100. Such pairing may allow multiple wearable items or objects to illuminate simultaneously, enabling synchronized lighting effects across devices. When one motion-activated module 100 detects movement and activates its corresponding lights 114, any paired motion-activated module 100 may likewise replicate the lighting response. By way of non-limiting example, when a first wearer spins, causing illumination of a dress incorporating a motion-activated module 100, one or more other dresses paired thereto may illuminate in coordination. In another non-limiting example, the bouncing of a ball incorporating a motion-activated module 100, causes one or more other balls paired thereto to illuminate in coordination.

In some cases, the motion-activated module 100 may be controllable via a remote-control device. The remote-control device may communicate with the motion-activated module 100 using infrared signals, radio frequency signals, or other wireless communication protocols. The remote-control device may comprise buttons or other input elements that allow a user to select lighting modes, adjust brightness levels, change colors, or activate specific lighting effects. The motion-activated module 100 may comprise a receiver configured to receive signals from the remote-control device and may respond to received commands by adjusting its operation.

The wireless communication capabilities may enable firmware updates to be transmitted to the motion-activated module 100. Firmware stored in memory of a processor 102 within the motion-activated module 100 may define the operating behavior of the motion-activated module 100, including motion detection algorithms, filtering parameters, transfer functions, and lighting effect patterns. Updated firmware may be transmitted wirelessly from an external device to the motion-activated module 100 via Bluetooth or another wireless protocol. The processor 102 may receive the updated firmware and may store the updated firmware in memory, replacing or supplementing previous firmware. Firmware updates may add new lighting effects, modify motion response characteristics, fix software issues, or provide other functional enhancements without requiring physical modification of the motion-activated module 100.

In some cases, the motion-activated module 100 may include calibration capabilities. The motion-activated module 100 may perform self-calibration to establish baseline sensor readings and compensate for sensor drift or mounting variations. Self-calibration may be performed automatically when the motion-activated module 100 is powered on, or may be initiated by a user through a button press, wireless command, or other input. During self-calibration, the processor 102 may sample data from the motion sensor 104 while the garment is stationary and may compute offset values that compensate for sensor bias or orientation. The computed offset values may be stored in memory and may be applied to subsequent motion sensor readings to improve accuracy of motion detection.

The motion-activated module 100 may include sensitivity adjustment capabilities. Sensitivity adjustment may allow a user to modify the responsiveness of the motion-activated module to detected movement. A user may increase sensitivity to cause the motion-activated module 100 to respond to smaller or slower movements, or may decrease sensitivity to cause the motion-activated module 100 to respond to larger or faster movements. Sensitivity adjustment may be performed by modifying threshold values, filter parameters, or transfer function coefficients used by the processor 102 to process motion data and control lighting output. Sensitivity adjustment may be performed via wireless commands from an external device, via a remote control, or via physical controls such as buttons or switches on the motion-activated module 100.

In some cases, the motion-activated module 100 may include user-selectable modes. Each user-selectable mode may define a different combination of motion response characteristics, lighting effects, colors, or other operating parameters. A user may select among available modes to customize the behavior of the motion-activated module 100 for different activities, preferences, or occasions. For example, a first mode may provide bright, responsive illumination suitable for performance or active play, while a second mode may provide subtle, gradual illumination suitable for quieter activities. A third mode may provide specific color schemes or lighting patterns associated with particular themes or events. Another user-selectable mode may provide illumination independent of motion or other sensor inputs. In this mode, the motion-activated module 100 may include a button or similar user interface element configured to trigger timed or continuous illumination. Upon actuation of the button, the processor 102 may cause the lights 114 to illuminate regardless of motion detected by the motion sensor 104. The lights 114 may remain illuminated until the button is actuated a second time, or illumination may instead be governed by timing parameters or optional motion-based control logic.

The user-selectable modes may be selected via wireless commands from an external device, via a remote control, or via physical controls on the motion-activated module 100. The processor 102 may store parameters for each available mode in memory and may load the parameters for a selected mode when the user selects that mode. The processor 102 may apply the loaded parameters to control motion detection, filtering, and lighting output according to the characteristics defined for the selected mode.

In some cases, the motion-activated module 100 may include adaptive behavior capabilities. The processor 102 may monitor motion patterns over time and may adjust operating parameters based on observed usage patterns. For example, the processor 102 may detect that a wearer typically spins at a particular velocity range and may adjust threshold or transfer function parameters to optimize lighting response for that velocity range. The processor 102 may store learned parameters in non-volatile memory so that adaptive adjustments persist across power cycles. Adaptive behavior may allow the motion-activated module 100 to customize its response characteristics to individual wearers or usage patterns without requiring manual configuration by the user.

In some aspects, the processor 102 of the motion-activated module 100 may comprise, incorporate, or otherwise utilize artificial intelligence (AI) or machine-learning algorithms to automatically adjust operating parameters based on observed usage patterns. Through continuous monitoring of motion data received from the motion sensor 104, as well as illumination behavior of the lights 114, the processor 102 may identify recurring user behaviors, preferred motion intensities, or typical activity profiles. Using such learned information, the processor 102 may dynamically refine threshold values, filtering parameters, transfer-function coefficients, or sensitivity levels to optimize responsiveness and improve the overall user experience.

Additionally, the learned parameters may enable advanced or enhanced illumination effects as part of a gamification system. For example, the processor 102 may track cumulative use metrics such as total spin count, duration of active illumination, frequency of specific movements, or other milestone-based criteria. Upon determining that predetermined or user-selectable thresholds have been met, the processor 102 may unlock or activate additional illumination modes or visual effects—including, but not limited to, new color schemes, patterns, animations, brightness profiles, or sequence behaviors within the lights 114. These additional effects may serve as incentives for continued engagement and may provide a customizable or progressive user experience based on each wearer's individual interaction history.

In standard operation, the motion-activated illumination system performs a sequence of processing steps to detect rotational movement and control illumination output in response to the detected movement. The operational cycle begins with motion sensing and proceeds through data processing stages that transform raw sensor data into illumination control signals.

The motion sensor 104 continuously samples acceleration and angular velocity data at a configured sampling rate. The accelerometer component of the motion sensor 104 measures linear acceleration along three orthogonal axes, producing a three-dimensional acceleration vector. The gyroscope component of the motion sensor measures angular velocity along three orthogonal axes, producing a three-dimensional angular velocity vector. The motion sensor 104 transmits the sampled acceleration and angular velocity data to the processor 102 via a communication interface at regular intervals corresponding to the configured output data rate.

The processor 102 receives the acceleration data from the motion sensor 104 and processes the acceleration data to estimate the gravity vector. The processor applies a low-pass filter to the acceleration data to attenuate dynamic acceleration components caused by movement while preserving the static gravitational acceleration component. The low-pass filtering operation produces a filtered acceleration vector that approximates the direction and magnitude of gravitational acceleration. The processor 102 normalizes the filtered acceleration vector by dividing the filtered acceleration vector by its magnitude, producing a unit gravity vector that points in the direction of Earth's gravitational field regardless of the orientation of the motion sensor 104.

The processor 102 receives the angular velocity data from the motion sensor 104 and computes the gravity-referenced rotational velocity by projecting the angular velocity vector onto the unit gravity vector. The projection operation comprises computing the dot product of the angular velocity vector and the unit gravity vector. The resulting scalar value represents the component of angular velocity that is aligned with the gravity axis, corresponding to rotation about the vertical axis. This projection isolates the rotational velocity associated with spinning or twirling motion from rotational velocity components associated with tilting, leaning, or other rotational movements that are not aligned with the vertical axis.

The processor 102 applies signal conditioning operations to the computed gravity-referenced rotational velocity. The processor 102 applies low-pass filtering to the rotational velocity signal to attenuate high-frequency noise and smooth rapid fluctuations in the signal. The processor 102 applies deadband filtering to treat rotational velocity values within a defined range near zero as zero, eliminating responses to minor movements or sensor noise. The processor 102 applies thresholding to define a minimum rotational velocity magnitude below which illumination is not activated. The combination of filtering and thresholding operations produces a conditioned rotational velocity signal that responds to spinning or twirling motion while rejecting other motion types.

The processor 102 maps the magnitude of the conditioned rotational velocity signal to an illumination control value using a transfer function. The transfer function defines the relationship between rotational velocity magnitude and illumination output level. The processor 102 computes the illumination control value by applying the transfer function to the conditioned rotational velocity magnitude. The processor 102 clamps the illumination control value to a valid range corresponding to minimum and maximum illumination levels.

The processor 102 generates a pulse-width modulation (PWM) signal based on the computed illumination control value. The duty cycle of the pulse-width modulation signal corresponds to the illumination control value, with higher illumination control values producing higher duty cycles and lower illumination control values producing lower duty cycles. The processor 102 outputs the PWM signal to drive the lights 114 coupled to the garment.

The lights 114 receive the PWM signal and illuminate at a brightness level corresponding to the duty cycle of the PWM signal. Higher duty cycles produce brighter illumination, while lower duty cycles produce dimmer illumination. A duty cycle of zero produces no illumination, while a duty cycle of one hundred percent produces maximum illumination. The brightness of the lights 114 thereby corresponds proportionally to the magnitude of the gravity-referenced rotational velocity detected by the motion sensor 104.

The operational cycle repeats continuously while the system is powered. At each sampling interval, the processor 102 receives updated acceleration and angular velocity data from the motion sensor 104, recomputes the gravity vector and gravity-referenced rotational velocity, applies signal conditioning, computes an updated illumination control value, and adjusts the PWM signal accordingly. The continuous repetition of the operational cycle allows the illumination output to track changes in rotational velocity in real time, increasing brightness as the wearer spins faster and decreasing brightness as the wearer spins slower or stops spinning.

The power source (e.g., at least one battery 106) provides electrical power to the motion sensor 104, the processor 102, and the lights 114 throughout the operational cycle. The power source supplies operating voltage to the motion sensor 104 to enable continuous sampling of acceleration and angular velocity data. The power source supplies operating voltage to the processor 102 to enable continuous execution of the processing operations. The power source supplies current to the lights 114 via the PWM output of the processor 102, with the average current delivered to the lights 114 corresponding to the duty cycle of the PWM signal.

In some aspects, the processor 102 may be configured to provide a low-battery indication using the existing lights 114. When the motion-activated module 100 is powered on, the processor 102 may evaluate a battery-level signal associated with the power source 106. If the detected battery level falls below a predetermined threshold, the processor 102 may cause the lights 114 to execute a predefined flashing pattern to indicate a low-battery condition. This visual indication may be provided without the use of screens, displays, or other dedicated user-interface components, thereby utilizing existing illumination hardware to communicate battery status.

The interaction of the motion sensor 104, processor 102, power source 106, and lights 114 forms a closed-loop system wherein physical movement of the garment produces corresponding changes in illumination output. The motion sensor 104 transduces physical movement into electrical signals representing acceleration and angular velocity. The processor 102 transforms the electrical signals into illumination control signals through the sequence of gravity vector estimation, rotational velocity projection, signal conditioning, and transfer function mapping. The lights 114 transduce the illumination control signals into visible light output. The wearer perceives the visible light output as visual feedback corresponding to the rotational movement of the garment.

In some aspects, the processor 102 may be configured to enter a low-power or sleep state when no rotational velocity is detected for a defined period of time. After the conditioned rotational velocity signal produced from the motion sensor 104 remains below a predetermined threshold for a specified duration, the processor 102 may reduce its sampling rate, deactivate non-essential processing functions, or otherwise transition the motion-activated module 100 into a reduced-power operating mode to conserve energy. The processor 102 may subsequently exit the low-power state upon detecting that the magnitude of the rotational velocity, as measured by the motion sensor 104, exceeds a wake threshold. Once awakened, the processor 102 may resume full sampling, filtering, and illumination control operations, including modulating the brightness of the lights 114 according to the detected motion. This power-management functionality may extend battery life while maintaining seamless responsiveness to user movement.

Accordingly, motion-activated module 100 disclosed herein solves the need for a motion responsive dynamic feedback system for clothing or other wearables by providing responsive illumination effects, sound, or other feedback based on real-time user activity. This not only enhances the visual and audible impact of performances, but also fosters a more immersive and interactive experience for the wearer, audience, child and more. The system may be implemented using any motion sensor, illumination device, power source, and wearable or non-wearable formfactor, and may control any light characteristic including brightness, color, pattern, animation, or sequencing based on gravity-referenced rotational motion.

While an inner layer 116 was shown and described, it will be appreciated that the components of the inner layer 116, such as the wires 118 and lights 114, may be located on an outer layer in a multi-layer garment, or may be on any surface of a single-layered garment. Additionally, the placement and number of lights 114 may vary without departing herefrom.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

1. A wearable garment with motion-activated illumination, comprising:
a garment body configured to be worn by a user;
a motion-activated module coupled to the garment body, the motion-activated module comprising a processor, a motion sensor in communication with the processor, and a power source, wherein the motion sensor includes an accelerometer configured to measure linear acceleration along three axes and a gyroscope configured to measure angular velocity along three axes; and
a plurality of lights distributed across the garment body and electrically connected to the motion-activated module;
wherein the processor is configured to:
determine a gravity vector based on accelerometer data from the accelerometer,
project the angular velocity measured by the gyroscope onto the gravity vector to calculate a spin rate representing rotational velocity about a gravity-referenced axis, and
control illumination of the plurality of lights based on the calculated spin rate.

2. The wearable garment of claim 1, wherein the processor is configured to apply a low-pass filter to the accelerometer data to isolate the gravity vector.

3. The wearable garment of claim 2, wherein the processor is configured to normalize the gravity vector to produce a unit vector.

4. The wearable garment of claim 3, wherein the processor is configured to compute a dot product of an angular velocity vector from the gyroscope and the unit vector to calculate the spin rate.

5. The wearable garment of claim 1, wherein the processor is configured to map a magnitude of the spin rate to one or more of a brightness level, a color, a pattern, an animation, a flashing, or other sequencing of the plurality of lights, wherein the brightness level, the color, the pattern, the animation, the flashing, or the sequencing changes proportionally based on the magnitude of the spin rate.

6. The wearable garment of claim 1, wherein the processor is configured to apply filtering to the spin rate to reduce noise and prevent flicker of the plurality of lights, wherein the filtering includes at least one of a low-pass filter, a deadband filter, or threshold detection.

7. The wearable garment of claim 1, wherein the plurality of lights comprises light-emitting diodes arranged in a horizontal pattern extending around a circumference of the garment body.

8. The wearable garment of claim 1, further comprising an inner layer coupled to the garment body, wherein the inner layer is removably attachable to the garment body via a zipper, and wherein the motion-activated module and the plurality of lights are coupled to the inner layer.

9. The wearable garment of claim 1, wherein the garment body comprises a dress having a bodice portion and a skirt portion, and wherein the plurality of lights is distributed across the skirt portion.

10. The wearable garment of claim 1, wherein the motion sensor comprises an inertial measurement unit comprising the accelerometer and the gyroscope integrated on a single device.

11. The wearable garment of claim 1, further comprising wiring routed through channels in the garment body connecting the plurality of lights to the motion-activated module.

12. A method of providing motion-activated illumination in a wearable garment, comprising:
providing a motion-activated module coupled to the wearable garment, and a plurality of lights distributed across the wearable garment, wherein the motion-activated module includes a processor, an accelerometer, a gyroscope, and a power source;
measuring, by the accelerometer, linear acceleration data along three axes;
measuring, by the gyroscope, angular velocity data along three axes;
determining, by the processor, a gravity vector based on the linear acceleration data;
projecting, by the processor, the angular velocity data onto the gravity vector to calculate a spin rate representing rotational velocity of the wearable garment about a gravity-referenced axis; and
controlling, by the processor, illumination of the plurality of lights based on the calculated spin rate.

13. The method of claim 12, wherein determining the gravity vector comprises applying a low-pass filter to the linear acceleration data and normalizing the filtered data to produce a unit gravity vector.

14. The method of claim 13, wherein projecting the angular velocity data onto the gravity vector comprises computing a dot product of an angular velocity vector and the unit gravity vector.

15. The method of claim 12, wherein controlling illumination of the plurality of lights comprises mapping a magnitude of the spin rate to a brightness level of the plurality of lights, wherein the brightness level increases as the magnitude of the spin rate increases.

16. The method of claim 12, further comprising applying filtering to the spin rate to distinguish rotational spinning from other types of movement including walking, jumping, and arm movements.

17. A motion-activated illumination system for an object or a wearable item, comprising:
a motion-activated module comprising a processor, an inertial measurement unit in communication with the processor, and a power source;
a plurality of lights electrically connected to the motion-activated module;
wherein the processor is configured to:
modulate illumination of the plurality of lights based upon a calculation of a spin rate;
wherein the motion-activated module is configured to be coupled to the object or the wearable item such that the spin rate corresponds to a rotational velocity of the object or the wearable item about a vertical axis.

18. The motion-activated illumination system of claim 17, wherein the object or wearable item is selected from the group consisting of a dress, a skirt, a costume, a cape, a belt, a tiara, a wand, a stuffed animal, a ball, and a handheld toy.

19. The motion-activated illumination system of claim 17, wherein the plurality of lights comprises at least one of light-emitting diodes, fiber optics, or electroluminescent wire.

20. The motion-activated illumination system of claim 17, wherein the processor is configured to:
a. estimate a gravity vector from accelerometer data received from a three-axis accelerometer;
b. calculate a spin rate by projecting angular velocity data received from a three-axis gyroscope onto the estimated gravity vector;
c. modulate illumination of the plurality of lights proportionally to the calculated spin rate; and
d. apply signal conditioning to the spin rate including at least one of low-pass filtering, deadband filtering, or threshold detection.

21. The motion-activated illumination system of claim 17, wherein the processor is configured to sample data from the motion sensor while the object or the wearable item is stationary and is further configured to compute offset values that compensate for sensor bias or orientation.

22. The motion-activated illumination system of claim 17, wherein the processor is configured to deactivate non-essential processing functions, or otherwise transition the motion-activated module into a reduced-power operating mode to conserve energy, upon determining that a conditioned rotational velocity signal produced from the motion sensor remains below a predetermined threshold for a specified duration.

23. The motion-activated illumination system of claim 17, wherein the processor is configured to map detected motion characteristics using linear, logarithmic, exponential, or saturated transfer functions.

24. The motion-activated illumination system of claim 17, wherein the processor is configured to evaluate a battery-level signal associated with a battery and, upon determining that the battery-level signal is below a predetermined threshold, to cause the plurality of lights to execute a predefined flashing pattern to indicate a low-battery condition.
